(19) United States
(12) Patent Application Publication
(10) Pub. No.: US 2008/0212448 A1
(43) Pub. Date: Sep. 4, 2008

(54) Optical System

(75) Inventor: Alexander Padiy, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,433

(22) PCT Filed: May 16, 2006
(86) PCT No.: PCT/IB06/51533

§ 371 Date: Nov. 26, 2007

(30) Foreign Application Priority Data
May 31, 2005 (EP) 05104680.3

(51) Int. Cl. G11B 7/00

(52) U.S. Cl. 369/100

(57) ABSTRACT

The present invention relates to an optical system for performing radial tracking on an associated optical record carrier. The optical system contains an actuated radiation-emitting device capable of emitting a main beam for reading and/or recording information as readable effects in the carrier, and at least two auxiliary beams applicable for radial tracking. The tracking is performed from radiation reflected from auxiliary spots, the auxiliary spots being asymmetrically placed with respect to the main spot. The carrier contains readable effects arranged in tracks in one or more spiral(s), where the one ore more spiral(s) are separated by one or more guard band(s) (5, 15). The optical system is adapted to perform radial tracking from the reflected light of a first and second auxiliary beam being positioned in a first and a second guard band.

The present invention relates to an optical system for reproducing and/or recording optically readable effects on an associated optical record carrier and performing radial tracking on the optical record carrier. The invention further relates to a method for reproducing and/or recording optically readable effects on an associated optical record carrier.

In order to meet the demand of increasing information storage capacity the available optical media, i.e. compact disc (CD), digital versatile disc (DVD) and the Blu-ray Disc (BD), show a constant improvement in storage capacity. In these optical media the reproduction resolution has hitherto been mostly dominated by the wavelength of the reproduction radiation, and by the numerical aperture of the optical reproduction apparatus. However, since it is not easy to shorten the wavelength of the reproduction radiation or to increase the numerical aperture of the corresponding lens system, attempts to increase the recording density has pre-dominantly been focused at improving the recording media and/or the recording/reproduction method.

In particular, for optical media adapted for recording information two different approaches have been suggested: The land-groove format wherein information is recorded both in the groove of the track and next to the groove, and the groove-only format wherein the information is only recorded in the groove, e.g. the BD disc format. Both of these formats have advantages and disadvantages, in particular with respect to radial tracking and inter-track/symbol cross-write/erase issues.

Presently, the density limit reached by combining a track pitch of 240 nm with a channel bit length of 50 nm has shown that the capacity of the BD-type disc can potentially be increased from the current 23-25-27 GB up to 50 GB per layer of information on the media. However, an inherent conflict between further downscaling of the track pitch versus the need for stabile radial tracking and limited cross-write/erase problems is encountered in present state of the art discs. In particular, an optical storage method with both the advantages of the land-groove format with respect to stable radial tracking and the advantages of the groove-only format with respect to limited cross-write/erase problems is therefore desirable.

Recently two dimensional optical Storage (TwoDOS) has been demonstrated, see e.g. Alexander van der Lee et al. in Japanese Journal of Applied Physics, vol. 43, No 7B, 2004, p. 4912-4914. In the TwoDOS format information is written as a number of data rows in parallel along a broad spiral on a carrier, and the data is read-out in parallel from the spiral using an array of laser spots. However, for write-once and rewriteable media this is not convenient because each laser spot has to be independently controlled which thus requires multiple lasers or laser cavities. This will complicate and increase cost of the corresponding optical devices. Similarly, the heat dissipation of such optical devices increases proportional to the number of lasers or laser cavities.

Hence, an improved optical storage method would be advantageous, and in particular a more efficient and/or reliable optical system for reproducing and/or recording optically readable effects on an associated optical record carrier would be advantageous.

Accordingly, the invention preferably seeks to mitigate, alleviate or eliminate one or more of the above-mentioned disadvantages singly or in any combination. In particular, it may be seen as an object of the present invention to provide an optical system that solves the above mentioned problems of the prior art with both reliable reproducing and/or recording optically readable effects on an optical record carrier and increased storage density on the optical record carrier.

This object and several other objects may be obtained in a first aspect of the invention by providing an optical system for reproducing and/or recording optically readable effects on an associated optical record carrier, the system comprising:

an actuated radiation-emitting device capable of emitting

a main beam and a corresponding main spot for reading information as readable effects in the carrier and/or recording information as readable effects on the carrier, and

at least two auxiliary beams and corresponding auxiliary spots applicable for radial tracking, the at least two auxiliary beams comprising a first and a second auxiliary beam,

photodetection means capable of detecting reflected radiation from the optical record carrier,

the associated optical record carrier comprising, or being adapted for recording, readable effects arranged in tracks in one or more spirals, said one or more spirals being separated by guard bands,

wherein the optical system is adapted for tracking from radiation reflected from auxiliary spots, the auxiliary spots being asymmetrically placed with respect to the main spot.

The invention according to the first aspect is particularly but not exclusively advantageous for facilitating an optical system capable of recording/reproducing information on a carrier with a low track pitch, i.e. low track width. The possibility of a lowered track pitch does not jeopardize the radial tracking as the radial tracking is to be performed in the guard bands. The commonly used single optical storage system with a single spiral carrier format has an inherent conflict between the radial tracking provided by the groove and the wish to minimize the track pitch, a conflict that is solved by the present optical system by tracking from radiation reflected from auxiliary spots, the auxiliary spots being asymmetrically placed with respect to the main spot, since the auxiliary beams may be adapted for tracking while the main beam may be adapted for reading information as readable effects in a given track on the carrier and/or recording information as readable effects in a given track on the carrier. By actuation of the radiation-emitting device a large radial displacement of at least some of the main spot and auxiliary spots are translated into smaller radial displacement of other of the main spot and auxiliary spots. The position of the main spot may thereby be controlled very precisely, by controlling the position of the auxiliary spots. The location of the main and auxiliary spots may be adapted to a given optical record carrier, e.g. to a given number of tracks in a spiral, to a given track pitch, etc. The intensity of the main beam may be so large that recording of readable effects may be performed in a recording mode, whereas the intensity of the auxiliary beams is so low that the parts of the record carrier placed under the auxiliary spots is not influenced from the auxiliary spots, neither in a reading nor in a recording mode of the optical system.

The actuation of the radiation-emitting device may be an actuation such as a rotation, a twisting, a bending, etc., so that the radial orientation of the auxiliary spots with respect to the track direction may be changed.

The optional feature as defined in claim 2 is advantageous since it facilitates a cost effective way of providing a main spot asymmetrically with respect to the auxiliary spots. The main spot may be placed between the auxiliary spots or on one side of the auxiliary spots.

The optional features as defined in claim 3 are advantageous since a small change in angular position of the radiation-emitting device facilitates that for a first auxiliary spot positioned in a given guard band, the position of the main spot on a given track within a given spiral may be controlled with a high precision by positioning the second auxiliary spot in different guard bands. A change in angular position may be obtained from a rotation of the radiation-emitting device.

The optional features as defined in claims 4 and 5 are advantageous since by controlling the separation distance between the auxiliary spots and the main spot a system with a high selectivity can be provided both for the situation where the spiral pitch is an integer multiple of the track pitch, and where the spiral pitch is not an integer multiple of the track pitch.

The optional feature as defined in claim 6 is advantageous since the position of the main spot is maintained so as to follow a given track. Radial tracking is obtained by detecting the reflected radiation of the first and second auxiliary beams being positioned in a first guard band and the second auxiliary spot being positioned in a second guard band. The optical system may be adapted to perform radial tracking using such techniques as the push-pull (PP) method and the differential phase detection (DPD) method, etc.

In a second aspect, the present invention relates to a method for operating an optical system according to the first aspect of the invention, wherein the tracking, in a situation of use, is performed from radiation reflected from auxiliary spots, the auxiliary spots being asymmetrically placed with respect to the main spot.

In a third aspect, the invention relates to a computer program product being adapted to enable a computer system comprising at least one computer having data storage means associated therewith to control an optical system according to the second aspect of the invention.

This aspect of the invention is particularly, but not exclusively, advantageous in that the present invention may be implemented by a computer program product enabling a computer system to perform the operations of the second aspect of the invention. Thus, it is contemplated that some known optical system may be changed to operate according to the present invention by installing a computer program product on a computer system controlling the optical system. Such a computer program product may be provided on any kind of computer readable medium, e.g. magnetically or optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

Embodiments of the invention will be described, by way of example only, with reference to the drawings, in which

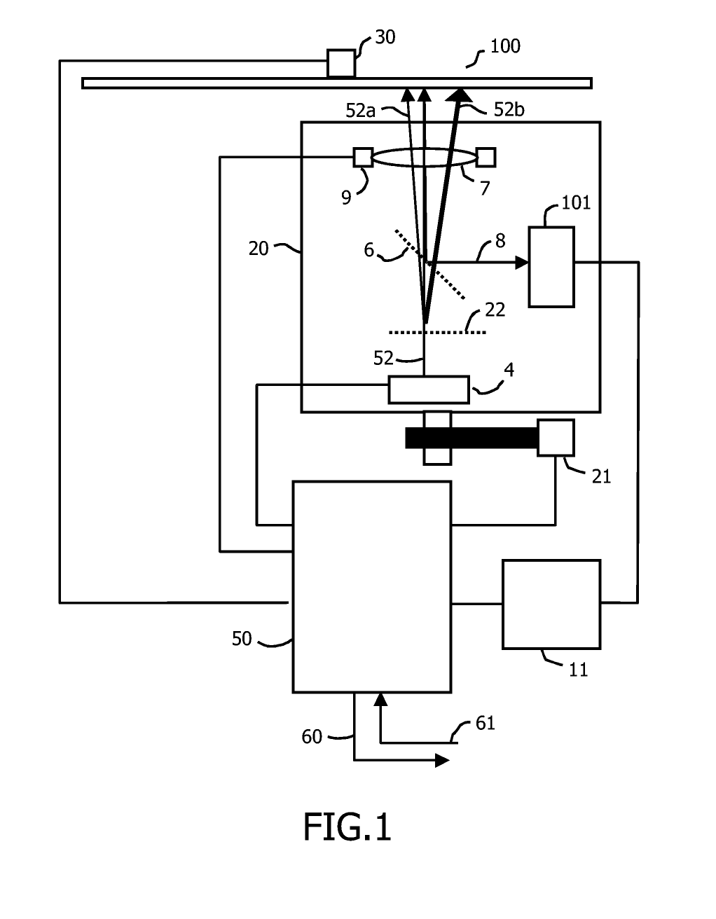

FIG. 1 schematically illustrates an embodiment of an optical system and associated carrier,

FIG. 2 schematically illustrates a first carrier format particularly suited for operation with the optical system according to the present invention,

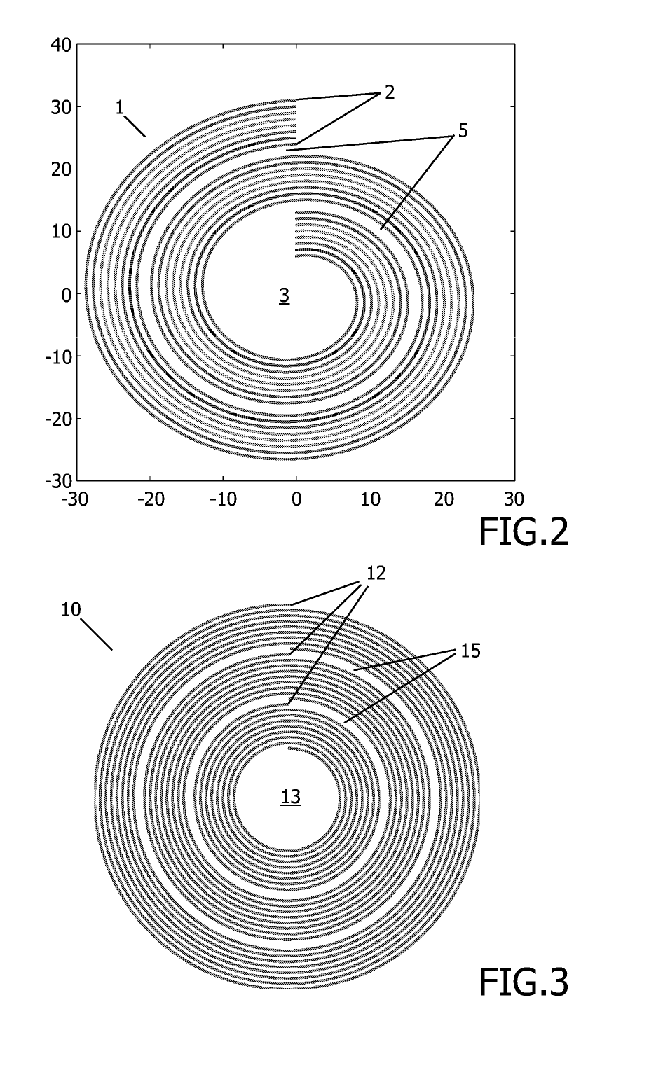

FIG. 3 schematically illustrates a second carrier format particularly suited for operation with the optical system according to the present invention,

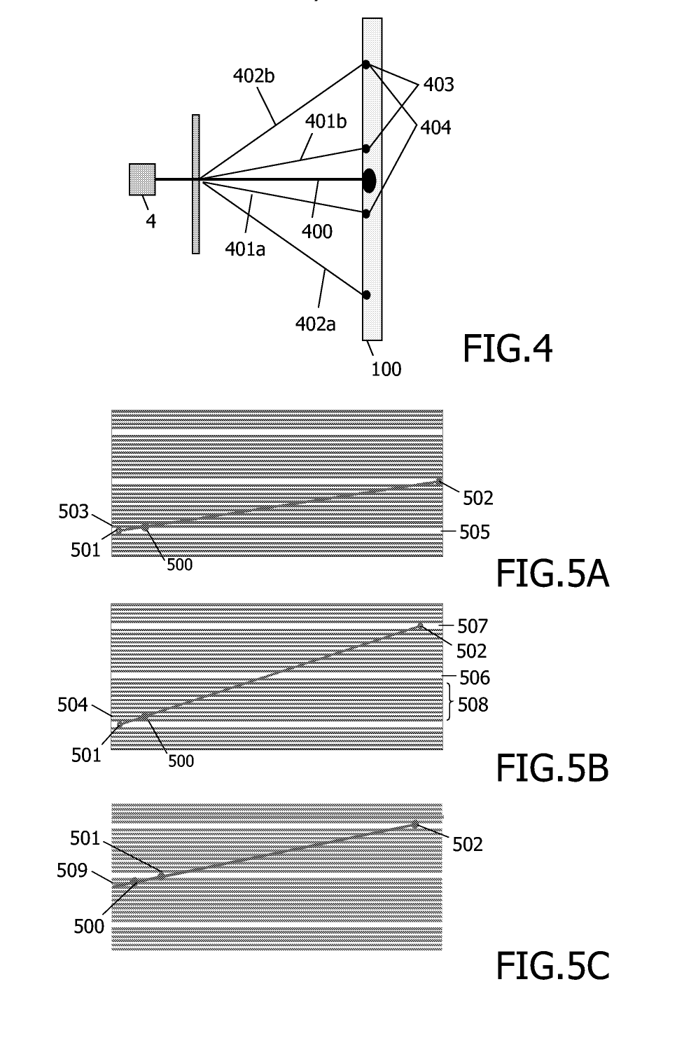

FIG. 4 schematically illustrates an embodiment of a radiation-emitting device wherein the tracking is performed from radiation reflected from asymmetrically placed auxiliary spots, and

FIG. 5 schematically illustrates the principle of operation of an embodiment of the present invention on a small cut-out section of a record carrier.

An embodiment of an optical system and associated carrier 100 is schematically illustrated in FIG. 1. The carrier 100 is fixed and rotated by holding means 30.

The carrier 100 comprises a material suitable for recording information by means of a radiation beam 52. The recording material may be of, for example, the magneto-optical type, the phase-change type, the dye type, metal alloys like Cu/Si or any other suitable material. Information may be recorded in the form of readable effects, i.e. optically detectable regions, also called marks for rewriteable media and pits for write-once media, on the carrier 100.

The apparatus comprises an optical head 20, sometimes called an optical pick-up (OPU), the optical head 20 being displaceable by actuation means 21, e.g. an electric stepping motor. The optical head 20 comprises a photodetection system 101, a radiation source 4, such as a laser, a beam splitter 6, an objective lens 7, and lens displacement means 9. The optical head 20 also comprises beam dividing means 22, such as a grating or a holographic pattern that is capable of splitting the radiation beam 52 into at least three components 52, 52a and 52b, i.e. a high intensity main beam and two low intensity auxiliary beams. The beam dividing means may be an actuated beam dividing means, e.g. the beam dividing means may be rotatable, twistable, bendable etc., so that the radial orientation of the auxiliary spots with respect to the track direction may be changed. The auxiliary beams 52a and 52b may be the diffraction beams of different order either on the same side (as shown here) or on different sides (not shown) of the main beam 52. For clarity reasons is the radiation beam 52, 52a, 52b shown as triplet single beam after passing through the beam splitting means 6, but more auxiliary spots may be present if e.g. the beam dividing means 22 is a grating. Similarly, the reflected radiation 8 also comprises more than one component, e.g. the reflections of the three spots 52, 52a, and 52b, and diffractions thereof, but only one beam 8 is shown here for clarity.

In this embodiment, the radiation source in combination with the beam dividing means (or grating) constitute the radiation-emitting device. This is a cost effective way of designing the radiation-emitting device. Equivalent means may however be envisioned, such as an array of aligned laser diodes capable of emitting radiation with different intensity. Instead of actuating the beam dividing means (or grating) the array should be actuated.

The function of the photodetection system 101 is to convert radiation 8 reflected from the carrier 100 into electrical signals. Thus, the photodetection system 101 may comprise more than one photodetector capable of generating one or more electric output signals that are transmitted to a pre-processor 11. The photodetectors may be arranged spatially to one another, and with a sufficient time resolution so as to enable detection of focus (FE) and radial tracking (RTE) errors in the pre-processor 11. Thus, the pre-processor 11 transmits focus (FE) and radial tracking error (RTE) signals to the processor 50. The processor 50 can also output control signals to the actuation means 21, the radiation source 4, the lens displacement means 9, the pre-processor 11, and the holding means 30. Similarly, the processor 50 can receive data, indicated at 61, and the processor 50 may output data from the reading process as indicated at 60.

The photodetection system 101 can also transmit a read signal or RF signal representing the information being read from the carrier 100 to the processor 50 through the pre-processor 11. The read signal may possibly be converted to a central aperture (CA) signal by a low-pass filtering of the RF signal in the processor 50.

The photodetector section holding an arrangement of the photodetector(s), such as photodiodes, CCDs, etc., may comprise two photodetectors for performing tracking by the push-pull (PP) method, where a relative weighting between the two detectors is applied for generating a radial error signal denoting the error or deviation from an intended radial position and the actual position. The photodetector section may, however, also be adapted for the differential phase detection (DPD) method, so that the section comprises four photodetectors. Such an embodiment, however, requires that data is provided in the guard band(s). Similarly, the photodetector section can consist of a single photodetector for radial tracking by applying the low-pass filtered signal from a pair of auxiliary spots.

In FIGS. 2 and 3 two particular optical carrier formats are illustrated. The formats are well suited for being applied in connection with an optical system according to the present invention. However, it is stressed that the principle of the present invention is not limited to these two formats.

FIG. 2 is a schematic drawing of a first carrier format. In this format, a plurality of tracks 2 are disposed substantially spirally and substantially concentrically with respect to central position 3 on the carrier. Each track 2 is adapted for recording and/or reproducing optically readable effects positioned substantially in a groove (not shown).

The plurality of tracks 2 are arranged adjacently in a multi-track spiral 1 on the optical record carrier. The number of tracks 2 in the broad spiral 1 is determined by a compromise between the radial servo system complexity and the storage capacity decrease due to the fact that the guard band 5 contains no data or possibly that the data density in the guard band 5 is lower than in the grooves of the broad spiral. The number of tracks in FIG. 2 is eight however any suitable number may be envisioned, in particular: 2, 3, 4, 5, 6, 7, 8, 9, 10, 11, 12, 13, 14, 15, 16, 17, 18, 19, and 20. The tracking area (guard band) 5 between the windings of the multi-track spiral 1 is adapted for providing a radial tracking error signal from the optical carrier 100.

FIG. 3 is a schematic drawing of a second carrier format. In this format, a plurality of tracks 12 are disposed substantially spirally and substantially concentrically with respect to a central position 13 on the carrier. Each track 12 is adapted for recording and/or reproducing optically readable effects positioned substantially in a groove (not shown). The plurality of spirals 10 are arranged in concentric consecutive layers 12 on the optical record carrier with one spiral in each layer similar to the structure of an onion. In FIG. 3 just three consecutive spirals 12 are shown for clarity but for an actual carrier the number of spirals 12 or “onion-shelves” may vary between 2 and 1.000.000. The tracking areas (guard band) 15 between the spirals 12 are adapted for providing a radial tracking error signal from the optical record carrier.

An almost-zero push-pull signal, or generally a radial tracking error signal, not suitable for tracking will be obtained within the tracks of the multi-spiral 1 or within the consecutive spirals 12. In the guard bands, however, the groove structure has a significant lower frequency component due to the larger track spacing there, and the push-pull tracking signal from the auxiliary spot is strong and will provides a clear radial tracking error signal, such as an “S-curve” around the middle of a guard band 5, 15. As a consequence the auxiliary spots 52a or 52b can reliably track the middle of the guard band 5 and 15 from the obtained radial tracking signal.

For Blu-ray optics, a guard band width down to 160-200 nm can be tolerated. The track pitch within the spiral can be chosen arbitrary as concerns the radial tracking system. In the rewritable and write-once systems the track pitch should be chosen large enough to prevent inter-track cross-write/cross-erase effects, while in the read-only system the track pitch should be chosen large enough to facilitate efficient mastering of the discs.

In a situation of 50% duty cycle, the duty cycle being the ratio between the groove width and the land width (or vice versa depending on the precise definition), the guard band width may be substantially equal to 1.5 times the track pitch. Such symmetric configurations where the optical system and the carrier format 1 and 10 are fitted together with respect to guard bands, track pitch and radial separation of the spots 52, 52a and 52b provides a particular advantage in connection with the present invention.

FIG. 4 illustrates an embodiment of a radiation-emitting device wherein the tracking is performed from radiation reflected from asymmetrically placed auxiliary spots, with respect to the main spots on an associated carrier.

The radiation-emitting device comprises a radiation source 4, such as a laser, and a diffraction grating 22. The diffraction grating splits a single laser beam in a number of angularly separated beams. The beam is split into a high-intensity zero-order beam 400 and a number of higher-order auxiliary beams of lower intensity (401a, 401b, 402a, 402b). The grating is designed so that all the higher orders get extremely low light intensity except for a few higher orders (e.g. the 1st-order and the 8th-order for the disc format with 8 tracks between the guard bands), which get an intensity sufficient for generation of the tracking signal. In this case, five beams are generated: main zero-order beam, two 1st-order auxiliary beams and two 8th-order beams positioned symmetrically with respect to the main beam. For implementing the tracking scheme, one of the 1st-order auxiliary beams together with one of the 8th-order beams either on the opposite side with respect to the main beam 404 or on the same side with respect to the main beam 403. Thus, even though the auxiliary spots are symmetrically placed, auxiliary spots of different order may be selected so that tracking is performed from radiation reflected from asymmetrically placed auxiliary spots, asymmetrically placed with respect to the main spot. The other two auxiliary beams may simply be ignored, since they do not influence the tracking.

Having the auxiliary beams on different side of the main beam is normally preferred, as lower orders are needed in this case since a simplified grating design and manufacturing may be obtained. Note, that for the same case of the disc format with 8 tracks between the guard bands, the 1st-order and the 10th-order are needed in the case when the auxiliary beams are located on the same side with respect to the main beam.

FIGS. 5A, 5B and 5C illustrate small cut-out sections of a record carrier. The main spot 500 is directed at different track positions 503, 504, 509 within a spiral 508 and the corresponding auxiliary spots 501 and 502 are placed in guard bands. In FIG. 5A the auxiliary spots are placed in adjacent guard bands 505, 506, in FIG. 5B the auxiliary spots are placed in two guard bands 505, 507 separated by a single guard band, whereas in FIG. 5C the auxiliary spots are also placed in auxiliary guard bands 506 and 507, however on the same side of the main spot. Eleven tracks are present giving rise to a spiral pitch 12 times larger than the track pitch within the spiral (guard band in this case is made by writing an “empty” track of the regular width after writing of every 11 regular tracks).

In the situation of FIGS. 5A and 5B where the auxiliary spots are placed at different sides of the main spot, the main spot and the two auxiliary spots are produced such that the distance between the auxiliary spot 501 and the auxiliary spot 502 is 12 times larger than the distance between the main spot and the auxiliary spot 501, by using a suitable diffraction grating. In this case, when the auxiliary spots are placed on the adjacent guard bands, as depicted in FIG. 5A, the main spot is placed exactly on the track #1 503 within the spiral. In the situation as depicted in FIG. 5C, where the auxiliary spots are placed at the same side of the main spot, the main spot and the two auxiliary spots are produced such that the and the distance between the main spot 500 and the auxiliary spot 502 is 12 times larger than the distance between the auxiliary spot 501 and the auxiliary spot 502.

The FIGS. 5A and 5B illustrate a situation where the main spot is placed at different tracks.

For placing the main spot on the track #2 504, the auxiliary spot 52 is moved to, or placed at, the next guard band 507 upwards as depicted in FIG. 5B while keeping the auxiliary spot 501 on the same guard band as illustrated in FIG. 5A. This may e.g. be achieved by rotating the grating in the optical pick-up. If the distance between the auxiliary spots is significantly larger than the spiral pitch, i.e. if the tilt angle α of the grating with respect to the track direction is small enough in order to allow the approximation sin(α)=α, then the main spot will be placed on the track #2 within the spiral. The above small-angle requirement is normally fulfilled for record carrier/optical system geometries used in practice.

A rotation of the grating, or other equivalent means, for moving an auxiliary spot to a different guard band will lead to that the reflected spots on the photo-detector are also moved slightly across the photo-detector. This leads to a small offsets in the tracking signals. The off-set situation may either be accepted “as is” or the movement may be corrected for. One of the options of correction is to rotate the photo-detector in tune with rotating the grating. Another option is to use offset compensation in the electronics—the offset level can be measured as a function of the grating angle, and then subtracted from the signal during tracking.

By moving the auxiliary spot 502 further upwards (not shown) with respect to the auxiliary spot 501 the main spot can be positioned on any given track within the broad spiral.

In the situation as depicted in FIGS. 5A and 5B where the auxiliary spots are placed at different sides of the main spot, an even better selectivity with respect to positioning of the main spot on a certain track can be achieved by having a distance between the main spot and the auxiliary spot 502 which is substantially equal to an integer times the number of tracks times the separation distance between the main spot and the auxiliary spot 501. For example, the distance between the main spot and the auxiliary spot 502 may be N*11 times larger than the distance between the main spot and the auxiliary spot 501, N being an integer. In order to move the main spot one track upwards the auxiliary spot 502 should be moved N guard bands up. Such a system with higher selectivity can be also applied if the spiral pitch is not an integer multiple of the track pitch within the broad spiral.

In the situation as depicted in FIG. 5C where the auxiliary spots are placed at the same side of the main spot an even better selectivity with respect to positioning of the main spot on a certain track can be achieved by similar means. In this situation the distance between the auxiliary spot 501 and the auxiliary spot 502 should be substantially equal to an integer times the number of tracks times the separation distance between the main spot and the auxiliary spot 501.

The geometry details of the disc are known so that the positioning of the main spot in response to a movement of the auxiliary spots is determined beforehand. In a situation where different competing formats may be present, the system may be adapted to recognize a given format and move the auxiliary spots in accordance with the specific format.

In a given embodiment independent movement of the auxiliary spots is obtained by an actuated grating in combination with two independent tracking systems for the auxiliary spots. Radial positioning of the first auxiliary spot can be achieved by the same means as in the regular single-spot optical system (by moving the pickup head and/or the objective lens), and radial positioning of the second auxiliary spot can be achieved by rotating the grating while keeping the first auxiliary spot on the selected guard band.

In a situation of use, a desired spiral can be selected by locating the first auxiliary spot on a particular guard band, while a desired track within the spiral can be selected by locating the second auxiliary spot at a guard band, separated by a certain number of guard bands with respect to the first auxiliary spot.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical system for reproducing and/or recording optically readable effects on an associated optical record carrier (100), the system comprising:
an actuated radiation-emitting device (4,22) capable of emitting
a main beam (400) and a corresponding main spot (500) for reading information as readable effects in the carrier and/or recording information as readable effects on the carrier, and
at least two auxiliary beams (401a-402b) and corresponding auxiliary spots (501,502) applicable for radial tracking, the at least two auxiliary beams comprising a first and a second auxiliary beam,
photodetection means (101) capable of detecting reflected radiation from the optical record carrier,
the associated optical record carrier comprising, or being adapted for recording, readable effects arranged in a plurality of tracks (2, 12) arranged in one or more spirals (1, 10), said one or more spirals being separated by guard bands (5, 15),
wherein the optical system is adapted for tracking from radiation reflected from auxiliary spots, the auxiliary spots being asymmetrically placed with respect to the main spot.

2. An optical system according to claim 1, wherein radiation-emitting device comprising a grating (22) adapted for suppressing at least some of the higher order beams.

3. An optical system according to claim 1, wherein the first and second auxiliary spots (501, 502) are placed in first and second guard bands (505-507), the guard band being separated by a number of spirals from each other, by controlling an angular position of the radiation-emitting device.

4. An optical system according to claim 1, wherein the separation distance between the second auxiliary spot and the main spot is substantially equal to an integer times the separation distance between the first auxiliary spot and the main spot.

5. An optical system according to claim 4, wherein the integer is equal to the number of tracks in a spiral or equal to an integer multiple of the number of tracks in a spiral.

6. An optical system according to claim 1 adapted to perform radial tracking from the reflected radiation of the first and second auxiliary beams, the first auxiliary spot being positioned in a first guard band and the second auxiliary spot being positioned in a second guard band, wherein the auxiliary spots are adapted to follow the guard bands independently of each other while the position of the main spot with respect to the auxiliary spots is maintained fixed so as to follow a given track.

7. Method for operating an optical system adapted for reproducing and/or recording optically readable effects on an associated optical record carrier (100), the system comprising:
an actuated radiation-emitting device (4, 22) capable of emitting
a main beam (400) and a corresponding main spot (500) for reading information as readable effects in the carrier and/or recording information as readable effects on the carrier, and
at least two auxiliary beams (401a-402b) and corresponding auxiliary spots (501, 502) applicable for radial tracking, the at least two auxiliary beams comprising a first and a second auxiliary beam,
photodetection means (101) capable of detecting reflected radiation from the optical record carrier,
the associated optical record carrier comprising, or being adapted for recording, readable effects arranged in a plurality of tracks arranged in one or more spirals, said one or more spirals being separated by guard bands,
wherein the tracking, in a situation of use, is performed from radiation reflected from auxiliary spots, the auxiliary spots being asymmetrically placed with respect to the main spot.

8. A computer program product being adapted to enable a computer system comprising at least one computer having data storage means associated therewith to control an optical system according to claim 1.

9. Use of an actuated radiation-emitting device (4, 22) for tracking from radiation reflected from at least two auxiliary spots on an optical record carrier, the auxiliary spots being asymmetrically placed with respect to a main spot for reading information as readable effects in the carrier and/or recording information as readable effects on carrier, and the optical record carrier comprising, or being adapted for recording, readable effects arranged in a plurality of tracks (2, 12) arranged in one or more spirals (1, 10), said one or more spirals being separated by guard bands (5, 15).
